(19) United States
(12) Patent Application Publication
(10) Pub. No.: US 2026/0149581 A1
(43) Pub. Date: May 28, 2026

(54) SEMICONDUCTOR DEVICE

(71) Applicant: Renesas Electronics Corporation, Tokyo (JP)

(72) Inventor: Yutaro KOGA, Tokyo (JP)

(21) Appl. No.: 19/368,230

(22) Filed: Oct. 24, 2025

(30) Foreign Application Priority Data
Nov. 26, 2024 (JP) 2024-205171

(51) Int. Cl. H04L 9/08

(52) U.S. Cl. CPC H04L 9/0894

(57) ABSTRACT

A semiconductor device is provided, the semiconductor device including: a RAM which stores an encryption key; a secure CPU which is permitted to access the encryption key stored in the RAM; and a first non-secure CPU which is connected to the RAM via a key access protect module and has a first user ID. The key access protect module stores user ID information of a non-secure CPU which is permitted to access the encryption key stored in the RAM, in association with the encryption key. When the first non-secure CPU tries to access the encryption key stored in the RAM, if the stored user ID information and the first user ID match each other, the key access protect module permits the first non-secure CPU to access the encryption key.

### CROSS-REFERENCE TO RELATED APPLICATION

The disclosure of Japanese Patent Application No. 2024-205171 filed on Nov. 26, 2024, including the specification, drawings and abstract is incorporated herein by reference in its entirety.

### BACKGROUND

The present disclosure relates to a semiconductor device.

An in-vehicle intellectual property (IP) core chip makes communication with various modules in a vehicle. It is necessary to protect data from wiretapping by encrypting in-vehicle communication. Related arts use controller area network (CAN) communication for the in-vehicle communication. However, a case of use of Ethernet has increased in recent years.

A secure central processing unit (CPU) dedicated to security processings is mounted on an in-vehicle chip for CAN communication. The secure CPU manages an encryption key used for encrypting the in-vehicle communication. CPUs other than the secure CPU are called non-secure CPUs, and make communication.

The in-vehicle chip executes various processings, and uses the in-vehicle communication when instructing a controller to acquire necessary information from a sensor. A plurality of systems or application software developed by other company execute this processing. A CPU is prepared for each of the systems in order to prevent the systems from interfering with each other. A module in which each CPU makes communication with the sensor and the controller is a common resource in the in-vehicle chip. In the CAN communication, not each CPU (non-secure CPU) but the secure CPU manages the key used for encrypting the communication.

There is disclosed technique listed below.

[Non-patent Document 1] IEEE Standard for Local and metropolitan area networks, Media Access Control (MAC) Security, IEEE Std 802.1AE (registered trademark)—2018

To the contrary, the case of the use of the Ethernet communication instead of the CAN communication has increased. The Non-patent Document 1 describes newly-defined standards called MACsec for encrypting the communication in the Ethernet.

### SUMMARY

However, the encrypted communication by MACsec uses more keys than that of the CAN communication, and the keys are more frequently updated. In the CAN communication, the keys can be managed by only the secure CPU. However, the processing performance of the secure CPU is too insufficient to apply the same processing to the MACsec standards. The enhancement of the performance of the secure CPU is difficult due to product cost constrains. Also, the tasks of the secure CPU increase in addition to the related technique, and therefore, the load for the MACsec cannot be increased. Accordingly, an objective of the present disclosure is to provide a semiconductor device in which an insufficient performance of a secure CPU is compensated by permitting a non-secure CPU to manage a key for MACsec.

Other objects and novel characteristics will become apparent from the description of the present specification and the accompanying drawings.

One embodiment provides a semiconductor device in which, when a first non-secure CPU tries to access an encryption key stored in a RAM, if a stored user ID information and a first user ID match each other, a key access protect module permits the first non-secure CPU to access the encryption key.

The one embodiment can provide a semiconductor device in which an insufficient performance of a secure CPU is compensated by permitting a non-secure CPU to manage a key for MACsec.

### BRIEF DESCRIPTIONS OF THE DRAWINGS

FIG. 1 is a block diagram illustrating a configuration of a related semiconductor device.

FIG. 2 is a diagram illustrating an outline of a semiconductor device according to the present disclosure.

FIG. 3 is a block diagram illustrating a first configuration of the semiconductor device according to the present disclosure.

FIG. 4 is a sequence diagram illustrating a first driving method of the semiconductor device according to the present disclosure.

FIG. 5 is a block diagram illustrating a configuration of the semiconductor device, corresponding to FIG. 4.

FIG. 6 is a sequence diagram illustrating a second driving method of the semiconductor device according to the present disclosure.

FIG. 7 is a block diagram illustrating a configuration of the semiconductor device, corresponding to FIG. 4.

FIG. 8 is a sequence diagram illustrating a third driving method of the semiconductor device according to the present disclosure.

FIG. 9 is a block diagram illustrating a configuration of the semiconductor device, corresponding to FIG. 8.

FIG. 10 is a block diagram illustrating a second configuration of the semiconductor device according to the present disclosure.

FIG. 11 is a sequence diagram illustrating a fourth driving method of the semiconductor device according to the present disclosure.

FIG. 12 is a block diagram illustrating a configuration of the semiconductor device, corresponding to FIG. 11.

FIG. 13 is a sequence diagram illustrating a fifth driving method of the semiconductor device according to the present disclosure.

FIG. 14 is a block diagram illustrating a configuration of the semiconductor device, corresponding to FIG. 13.

### DETAILED DESCRIPTION

For clear explanation, the following description and drawings are appropriately omitted and simplified. Each of elements illustrated in the drawings, respectively, as functional blocks that execute various types of processing, can be configured of a central processing unit (CPU), a memory, or another circuit in a hardware manner, or is achieved by a program or the like loaded in the memory in a software manner. Therefore, the functional blocks can be achieved by hardware, software operating on the hardware, or their combination. In each drawing, the same elements are respectively denoted by the same reference symbols, and description thereof is not repeated as needed.

The program can be stored by use of various types of a non-transitory computer readable medium, and can be supplied to a computer. The non-transitory computer readable medium includes various types of a tangible storage medium. Examples of the non-transitory computer readable medium include magnetic recording media (such as flexible disc, magnetic tape and hard disc drive), magnetooptical recording media (such as magnetooptical disc), CD-ROM (read only memory), CD-R, CD-R/W, semiconductor memories (such as mask ROM, programmable ROM (PROM)), erasable PROMs (EPROM), flash ROMs and random access memories (RAM). The program may be supplied to the computer by various types of a transitory computer readable medium. Examples of the transitory computer readable medium include electrical signals, optical signals and electromagnetic waves. By the transitory computer readable medium, the program can be supplied to the computer via a wired communication path such as an electric wire and an optical fiber or a wireless communication path.

### Description of Related Semiconductor Device

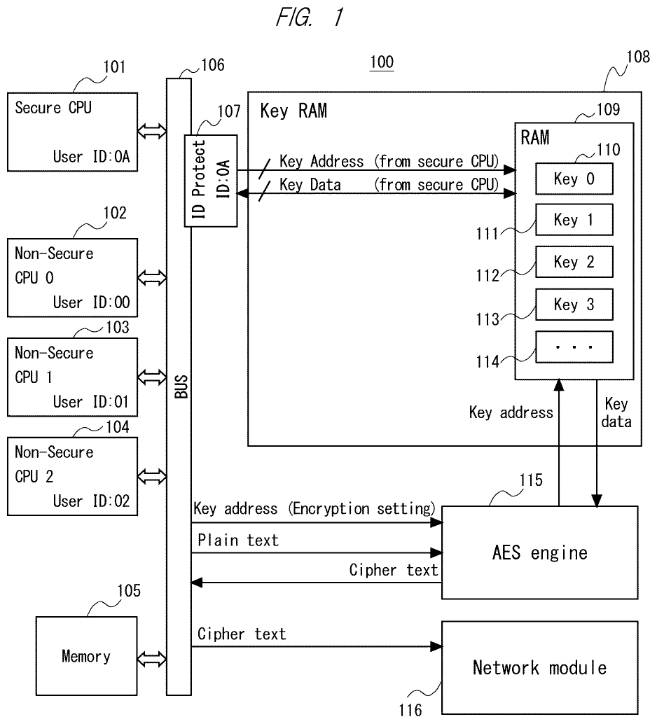

FIG. 1 is a block diagram illustrating a configuration of a related semiconductor device. The related semiconductor device will be described with reference to FIG. 1. The related semiconductor device is used for, for example, the encryption in the CAN communication.

As illustrated in FIG. 1, the related semiconductor device 100 includes a secure central processing unit (CPU) 101, a first non-secure CPU 102, a second non-secure CPU 103, a third non-secure CPU 104, a memory 105, a bus 106, an ID protect 107, a key random access memory (RAM) 108, an advanced encryption standard (AES) engine 115, and a network module 116.

The secure CPU 101 is a CPU executing the security processings. The secure CPU 101 cannot be used by a user. The secure CPU 101 is operated by only software verified and trusted by secure boot.

The first non-secure CPU 102, the second non-secure CPU 103, and the third non-secure CPU 104 are CPUs that can be used by the user. These CPUs control an automobile by using the CAN communication.

The bus 106 connects each CPU to each semiconductor-device component such as the memories such as the key RAM 108, the AES engine 115, and the network module 116.

The ID protect 107 limits an accessible CPU by using a user ID. In this case, only the secure CPU 101 can access the key RAM 108.

The key RAM 108 is a module for managing keys used for the encryption. The key RAM 108 stores a key (key 0) 110, a key (key 1) 111, a key (key 2) 112, a key (key 3) 113, and a key 114 in a RAM 109. The key RAM 108 selects a key to be output to the AES engine 115. The key RAM 108 cannot be accessed from the non-secure CPU.

The AES engine 115 encrypts information which has not been encrypted yet. Besides, the AES engine 115 decrypts the encrypted information. For the AES engine 115, the non-secure CPU sets the encryption or the decryption. For the AES engine 115, the non-secure CPU sets a key address of the encryption key to be used for the encryption or the decryption. The AES engine 115 transmits the key address to the RAM 109, and receives key data. The AES engine 115 executes the encryption or the decryption by use of the received key data. In this case, whether the non-secure CPU does not use a key for a different user stored in the RAM 109 cannot be checked.

The encryption key is updated by transmission of a new encryption key and the address of the RAM 109 storing the encryption key to the key RAM 108 via the bus 106 executed by the secure CPU 101.

Management of keys by the non-secure CPU causes the following security problems. Firstly, there are various types of software executed by the non-secure CPU as different from the secure CPU executing only the verified trustable software. There is a risk of mixture of the malware (software) to rewrite and execute a code in the memory due to glitch. Secondly, if the malware can freely read out the encryption key in the key RAM via the non-secure CPU, the key leaks to the public. And, the leakage of the key used as the encryption key to the public loses security in the communication. There is a risk of interception or falsification of the communication data.

### Description of Semiconductor Device According to Embodiment

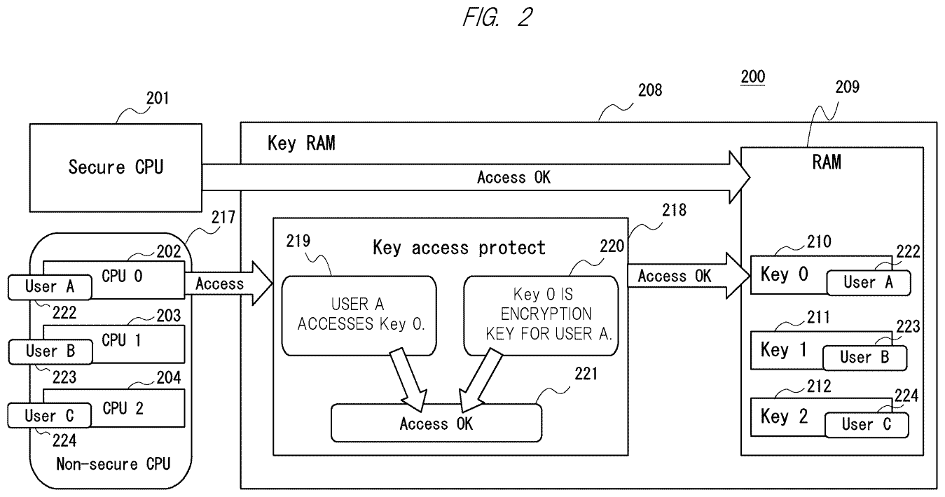

FIG. 2 is a diagram illustrating an outline of a semiconductor device according to the present disclosure. The semiconductor device according to the embodiment will be described with reference to FIG. 2.

In the semiconductor device 200 according to the embodiment, a non-secure CPU is in charge of managing the key for MACsec, thereby reducing a load on a secure CPU. As illustrated in FIG. 2, a key access protect module 218 as an access protect mechanism is added. A first non-secure CPU 202, a second non-secure CPU 203, and a third non-secure CPU 204 are connected to a RAM 209 via the key access protect module 218. Thus, the non-secure CPUs prevent an unauthorized user from accessing the encryption key, thereby ensuring the security.

The key access protect module 218 has the following functions. First, there is a function to identify an ID of a non-secure CPU having accessed the key RAM 208. Thereby, access of a user A 222 using the CPU 202 is identified (219).

There is another function to hold user ID information of a non-secure CPU in association with the encryption key, the non-secure CPU being permitted to access each encryption key stored in the key RAM 208. There is still another function to set an ID of the non-secure CPU being permitted to access each encryption key to only the secure CPU. Thus, it is certified that a key 210 (Key 0) is the encryption key for the user A 222 (220), and the access of the key 210 is permitted (221).

There is still another function to confirm, when the non-secure CPU updates the encryption key, whether this non-secure CPU has the authority to access the encryption key. When the first non-secure CPU tries to access the encryption key stored in the key RAM 208, if the stored user ID information and the first user ID match each other, the key access protect module permits the first non-secure CPU to access the encryption key.

The above configuration can provide the semiconductor device in which the insufficient performance of the secure CPU is compensated by permitting the non-secure CPU to manage the key for MACsec.

### Description of Semiconductor Device According to First Embodiment

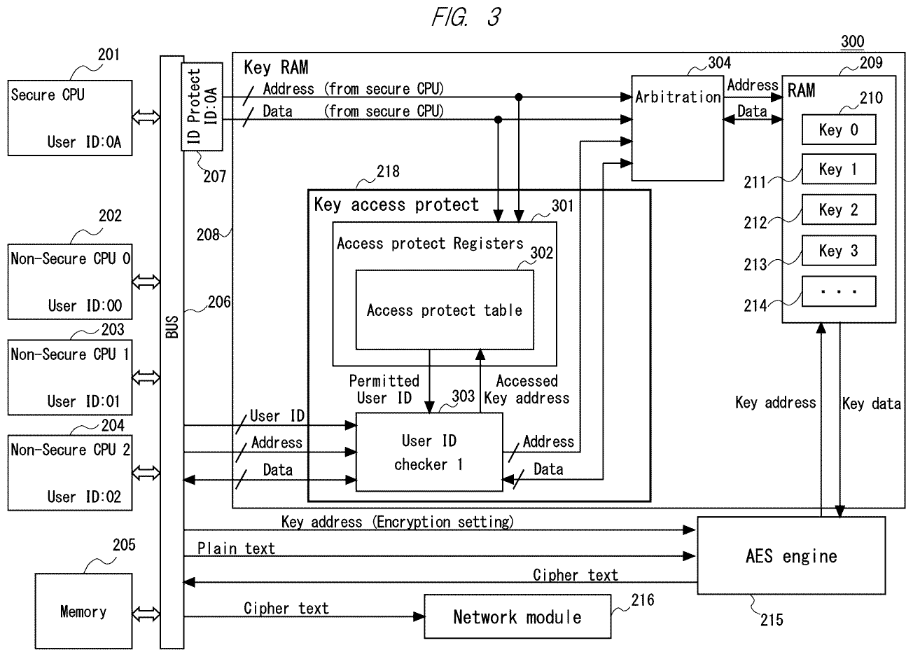

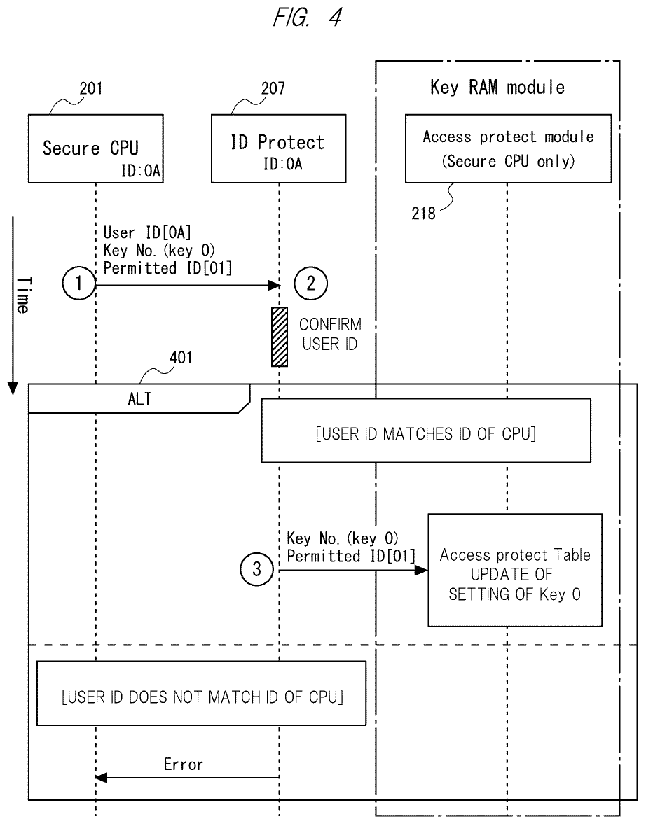

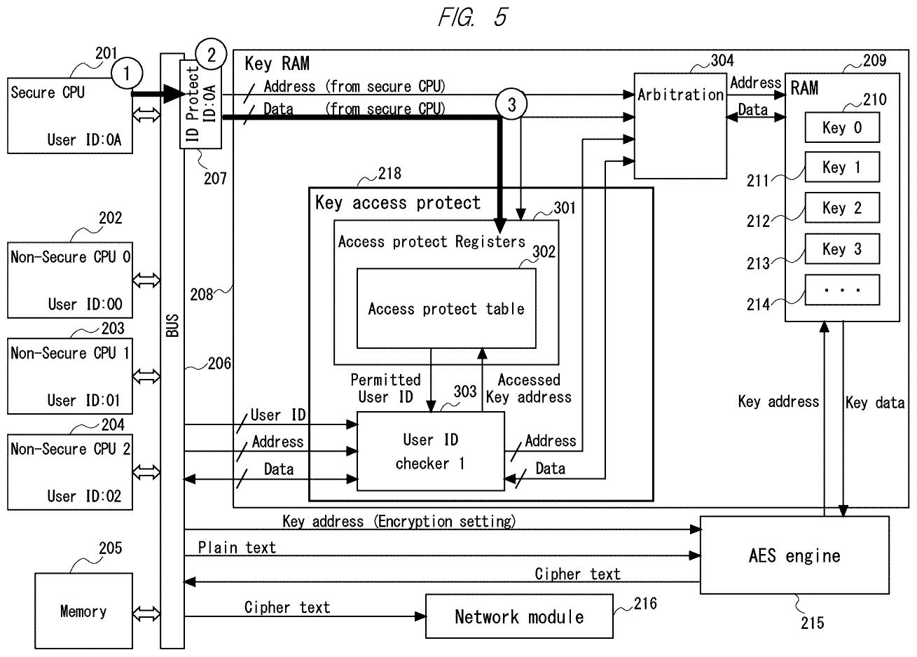

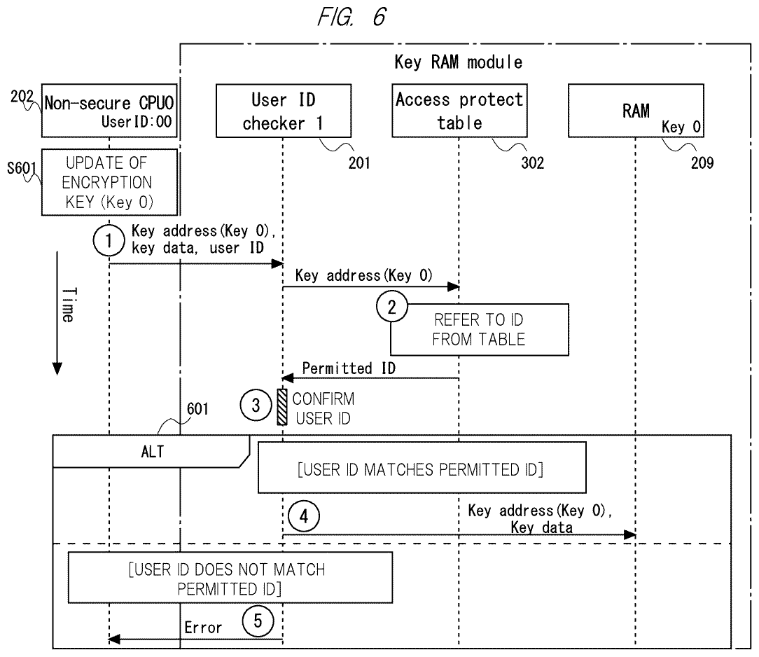

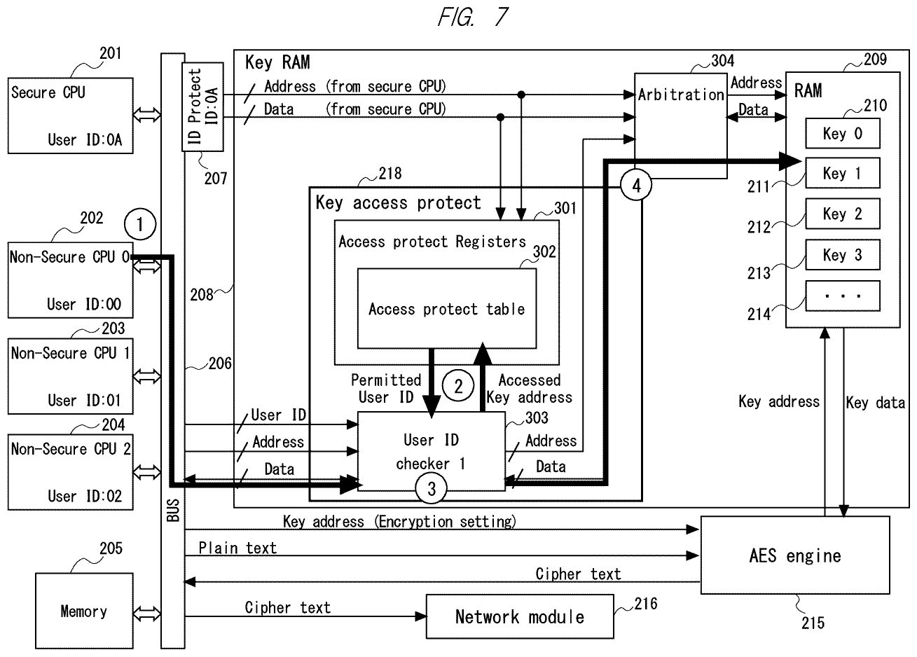

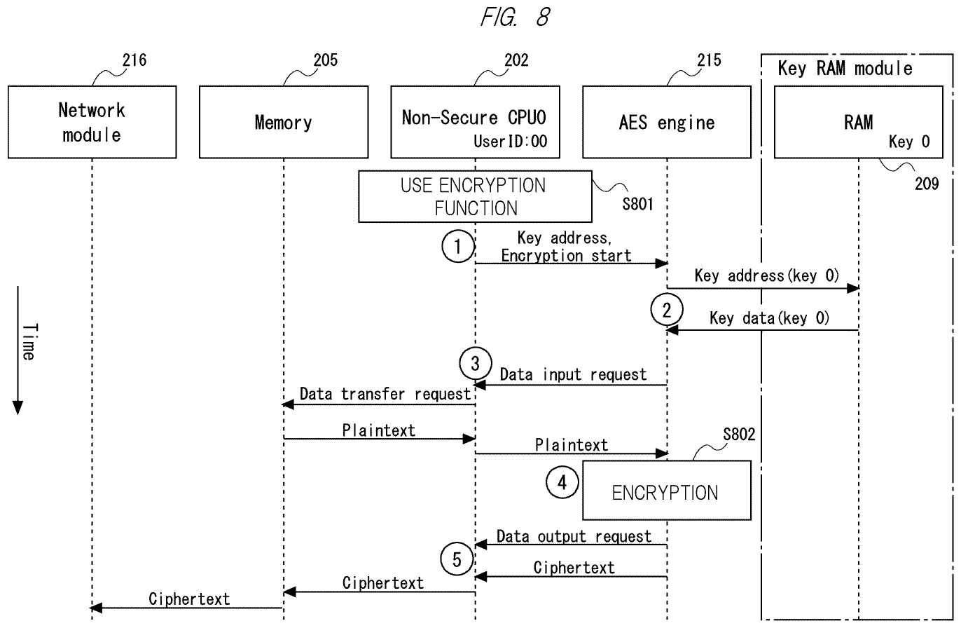

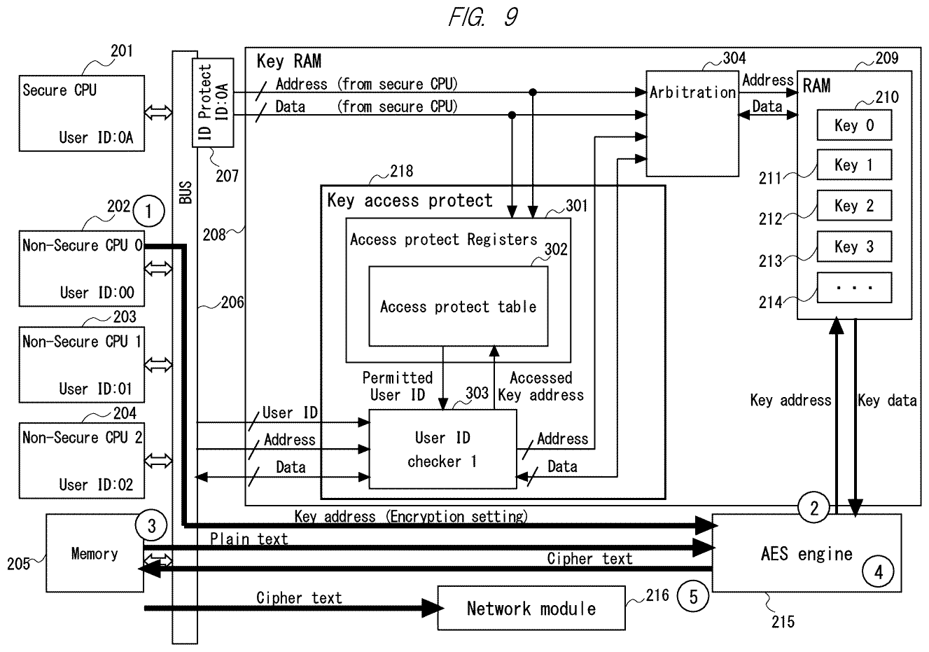

FIG. 3 is a block diagram illustrating a first configuration of a semiconductor device according to the present disclosure. FIG. 4 is a sequence diagram illustrating a first driving method of the semiconductor device according to the present disclosure. FIG. 5 is a block diagram illustrating a configuration of the semiconductor device, corresponding to FIG. 4. FIG. 6 is a sequence diagram illustrating a second driving method of the semiconductor device according to the present disclosure. FIG. 7 is a block diagram illustrating a configuration of the semiconductor device, corresponding to FIG. 6. FIG. 8 is a sequence diagram illustrating a third driving method of the semiconductor device according to the present disclosure. FIG. 9 is a block diagram illustrating a configuration of the semiconductor device, corresponding to FIG. 8. The semiconductor device according to the first embodiment will be described with reference to FIGS. 3 to 9.

The semiconductor device 300 according to the first embodiment includes the secure CPU 201, the first non-secure CPU 202, the second non-secure CPU 203, the third non-secure CPU 204, a memory 205, a bus 206, an ID protect 207, the key RAM 208, an AES engine 215, and a network 216.

Although not described herein, the functions of the secure CPU 201, the first non-secure CPU 202, and the second non-secure CPU 203 are the same as the functions of the secure CPU 101, the first non-secure CPU 102, and the second non-secure CPU 103, respectively. Although not described herein, the functions of the third non-secure CPU 204, the memory 205, the bus 206, and the ID protect 207 are the same as the functions of the third non-secure CPU 104, the memory 105, the bus 106, and the ID protect 107, respectively. Although not described herein, the functions of the key RAM 208, the AES engine 215, and the network 216 are the same as the functions of the key RAM 108, the AES engine 115, and the network module 116, respectively.

The Key RAM 208 includes the key access protect module 218, an arbitration circuit 304, and the RAM 209.

The key access protect module 218 includes access protect registers 301 with an access protect table 302, and a user ID checker 1 (303).

Each CPU has a user ID. For example, the secure CPU 201 has a user ID OA. The first non-secure CPU has a user ID 00. The second non-secure CPU has a user ID 01. The third non-secure CPU has a user ID 02.

Such a user ID is transferred together with address or data via the bus 206. Thus, it can be determined which CPU is making the access via the bus 206. The CPU cannot confirm and change such a user ID.

When the non-secure CPU tries to access the encryption key stored in the RAM 209, the user ID checker 1 (303) as the first user ID checker confirms in the access protect registers 301 whether the non-secure CPU has the user ID, and determines whether to permit the access in response to the confirmation result. The user ID checker 1 (303) compares the user ID of the CPU with the ID in the access protect table 302. If these IDs match each other, the user ID checker 1 (303) permits the access to the RAM. The user ID checker 1 (303) prevents the falsification by monitoring the key updating.

The access protect registers 301 set the user ID information of the non-secure CPU which is permitted to access the encryption key stored in the RAM 209. The access protect registers 301 are registers for setting the user ID of the CPU which is permitted to access each key. The access protect table 302 stores the user ID. Only the secure CPU 201 can set the access protect table 302.

By using the user ID, the ID protect 207 limits the CPU which is permitted to access the access protect registers 301 and the key RAM 208 to the secure CPU 201.

The memory 205 stores the program to be executed by the CPU.

FIGS. 4 and 5 illustrate a method of updating the access protect table 302. The access protect table 302 is provided with a register capable of setting, for each encryption key, the user IDs of the CPUs which are permitted to access, as described below.

TABLE 1

| Key No. | Ram address | Permitted ID |
|---|---|---|
| Key 0 | 0x0000 | ID: 01 |
| Key 1 | 0x0040 | ID: 03 |
| . . . | . . . | . . . |

A case of update of setting for the access protect table 302 executed by the secure CPU will be described with reference to FIGS. 4 and 5.

1. A write transaction in the secure CPU 201 for updating the access protect table 302 is issued. In this case, the number of the key (Key No.) for updating the setting and 0-th user ID as the user ID (permitted ID) which is permitted to access the key are transferred. When the transaction is issued as described above, the user ID: OA associated with the secure CPU 201 is also transferred.

2. The ID protect 207 is applied to the bus 206 such that only the secure CPU 201 can access the access protect table 302. In this case, it is determined that the CPU is the secure CPU by confirming the user ID transferred together with the transaction.

At this time, the processing proceeds to branch (ALT) 401.

3. When the ID protect 207 confirms the user ID, if the user ID matches the user ID of the secure CPU, the write transaction is issued to update the access protect table 302. If the IDs do not match each other, the write transaction is not issued, and an error is returned.

By the above configuration, the setting of the access protect table is updated in the secure CPU.

FIGS. 6 and 7 illustrate a method of updating the key by the non-secure CPU. The access protect table 302 stores the key addresses and the IDs of the CPUs which are permitted to access, as described below.

TABLE 2

| Key number | Ram address | Permitted ID |
|---|---|---|
| Key 0 | 0x0000 | ID: 01 |
| Key 1 | 0x0040 | ID: 03 |
| Key 3 | 0x0080 | ID: 02 |
| . . . | . . . | . . . |

A method of updating the key by the non-secure CPU will be described with reference to FIGS. 6 and 7.

1. The address of Key 0 and the encryption key are transferred from the CPU 0 as the first non-secure CPU 202 to the key RAM 208. In this case, the first user ID as the user ID of the CPU 0 is also transferred.

2. The user ID checker 1 (303) receives the user ID (permitted ID) of the CPU which is permitted to access the Key 0 by, regarding the address of the Key 0, referring to the access protect table 302 in the key access protect module 218 storing the user ID information.

3. The user ID checker 1 (303) compares the user ID of the CPU 0 with the user ID of the CPU which is permitted to access the Key 0.

At this time, the processing proceeds to branch (ALT) 601.

4. If the IDs match each other, the first non-secure CPU 202 is permitted to access the encryption key, and the key address and the encryption key are transferred, and then, the writing to the RAM 209 is executed.

5. If the IDs do not match each other, an error is output.

By the above configuration, the key is updated in the non-secure CPU.

FIGS. 8 and 9 illustrate a method of executing the encryption by the AES engine using the encryption key. The method of executing the encryption by the AES engine using the encryption key will be descried with reference to FIGS. 8 and 9. It is assumed herein that the first non-secure CPU 202 executes the encryption by using the Key 0.

1. The first non-secure CPU 202 sets the key to be used for the encryption into a control register of the AES engine 215, and sets an encryption start bit.

2. The AES engine 215 invokes a corresponding encryption key (key data) by transmitting, to the key RAM 208, the (key) address of the encryption key set in the control register for the encryption. After finishing the key invocation, the AES engine 215 transmits a signal which indicates the encryption preparation completion, to the first non-secure CPU.

3. The non-secure CPU 202 transfers a plain text which is stored in the memory 205, to the AES engine 215.

4. The AES engine 215 executes the encryption after receiving the full plain text. After finishing the encryption, the AES engine 215 transmits a signal which indicates cipher-text preparation completion, to the non-secure CPU 202.

5. The non-secure CPU 202 transfers a cipher text from the AES engine 215 to the memory 205. Then, the cipher text is transferred from the memory to the network module.

By the above configuration, the encryption is executed.

### Description of Semiconductor Device According to Second Embodiment

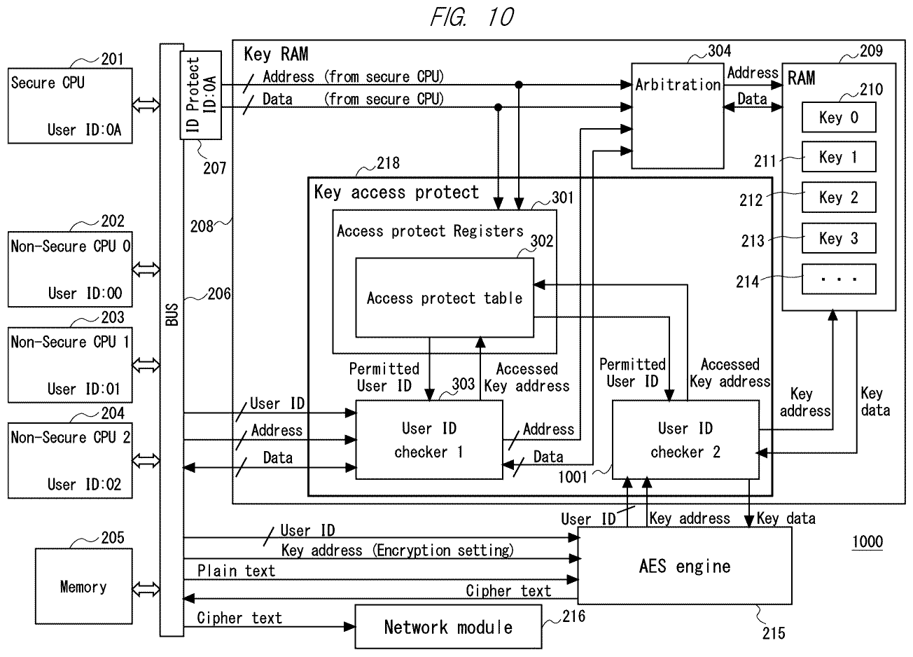

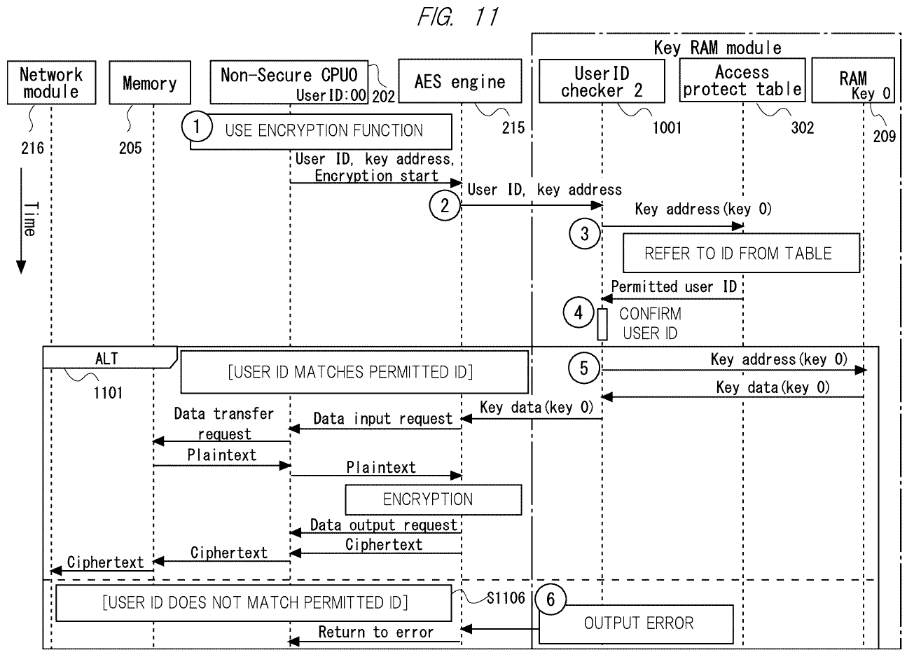

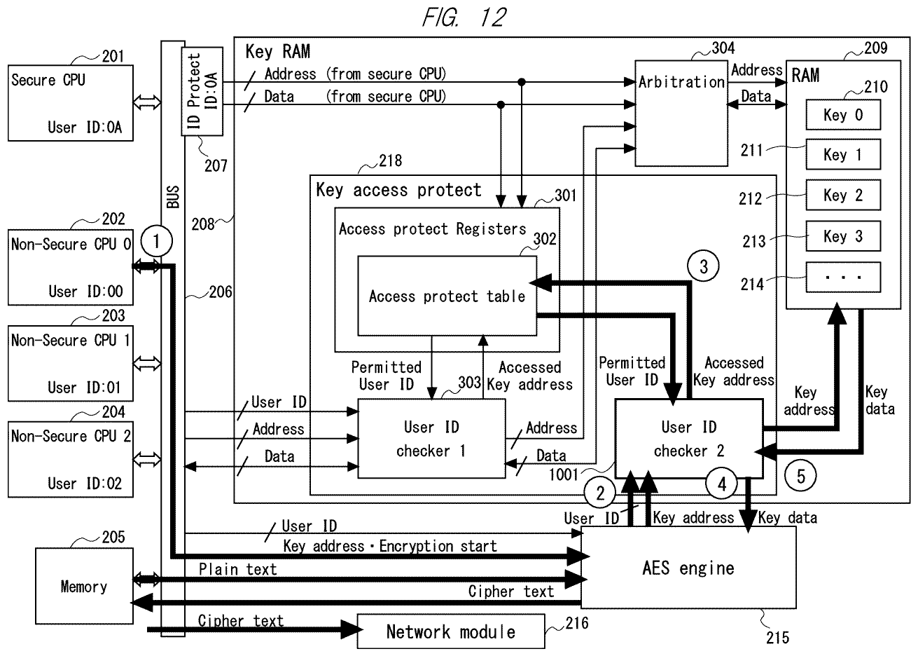

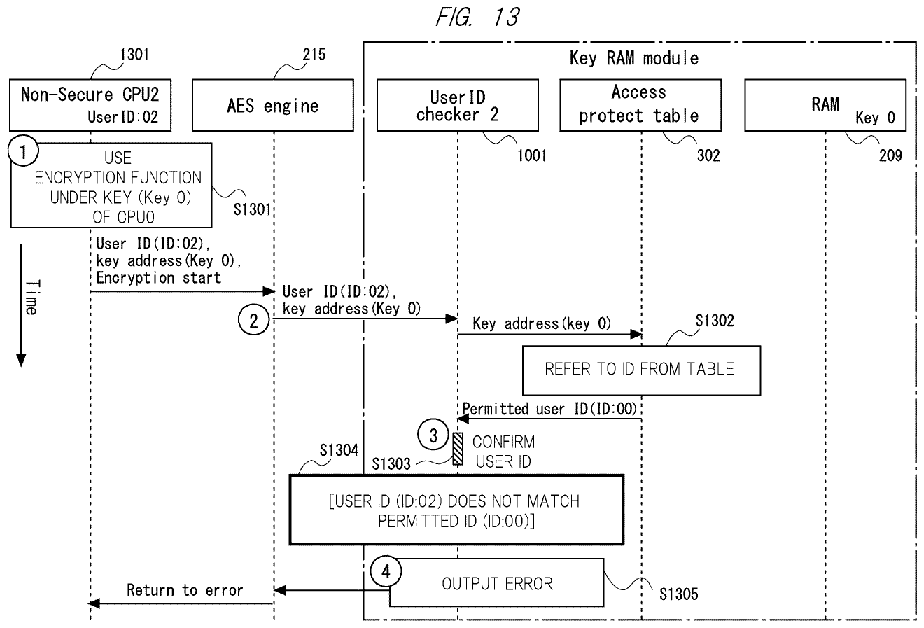

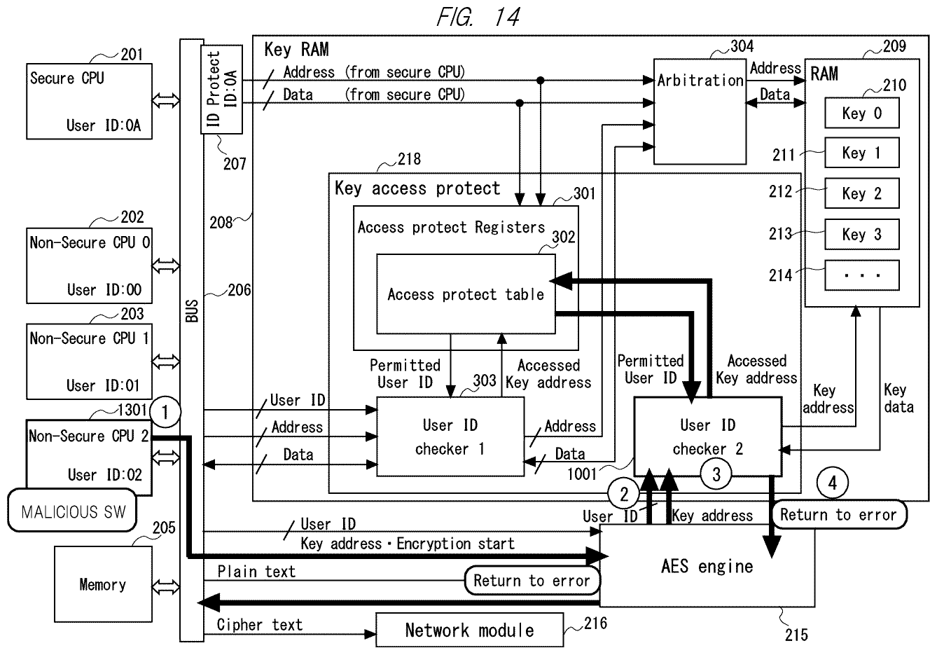

FIG. 10 is a block diagram illustrating a second configuration of the semiconductor device according to the present disclosure. FIG. 11 is a sequence diagram illustrating a fourth driving method of the semiconductor device according to the present disclosure. FIG. 12 is a block diagram illustrating a configuration of the semiconductor device, corresponding to FIG. 11. FIG. 13 is a sequence diagram illustrating a fifth driving method of the semiconductor device according to the present disclosure. FIG. 14 is a block diagram illustrating a configuration of the semiconductor device, corresponding to FIG. 13. A semiconductor device according to a second embodiment will be described with reference to FIGS. 10 to 14.

A semiconductor device 1000 according to the second embodiment is different from the semiconductor device 300 according to the first embodiment in that the semiconductor device 1000 includes a user ID checker 2 (1001) as a second user ID checker.

The key access protect module 218 includes the user ID checker 2 (1001) for determining, when the non-secure CPU uses the encryption key, whether the non-secure CPU is permitted to access the encryption key. The user ID checker 2 (1001) compares the user ID of the CPU with the ID in the access protect table. If the user IDs match each other, the user ID checker 2 (1001) permits the CPU to access the RAM 209. The user ID checker 2 (1001) monitors the use of the key, thereby preventing the spoofing.

FIGS. 11 and 12 illustrate a method of using the key in the RAM 209 by the AES engine 215. The method of executing the encryption by the AES engine 215 using the encryption key will be described with reference to FIGS. 11 and 12. It is assumed herein that the first non-secure CPU 202 executes the encryption by using the Key 0.

1. The non-secure CPU 202 sets a key to be used for the encryption into the control register of the AES engine 215, and sets an encryption start bit.

2. In order to execute the encryption, to the Key RAM 208, the AES engine 215 transfers the key address of the encryption key set into the control register and the user ID transferred at the time of the write transaction for the control register.

3. The user ID checker 2 (1001) transfers the key address requested by the AES engine 215 to the access protect table 302, and receives the user ID (permitted ID) of the CPU which is permitted to access the key.

4. The user ID checker 2 (1001) compares the user ID of the non-secure CPU 202 with the user ID of the CPU which is permitted to access the Key 0.

The processing proceeds to branch 1101.

5. If the IDs match each other, the user ID checker 2 (1001) invokes the encryption key (key data) from the RAM 209, and passes it to the AES engine 215. The AES engine 215 executes the encryption by using the encryption key.

6. If the IDs do not match each other, an error is output.

FIGS. 13 and 14 illustrate a method of executing the encryption by the second non-secure CPU 1301 which is hacked by malware to use the normally-unavailable Key 0. An anti-spoofing method will be described with reference to FIGS. 13 and 14.

1. The second non-secure CPU 203 sets the Key 0 to be used for the encryption into the control register of the AES engine, and sets an encryption start bit. The user ID (ID: 02) transferred at the time of the write transaction cannot be confirmed and changed by the second non-secure CPU 203.

2. To the key RAM 208, the AES engine 215 transfers the address (Key 0) of the encryption key and the user ID (ID: 02) transferred at the time of the write transaction for the control register.

3. The user ID checker 2 (1001) compares the user ID (ID: 02) of the CPU which is to execute the encryption with the permitted ID (ID: 00) which is permitted to access the Key 0.

4. Since the user IDs do not match each other, the user ID checker 2 (1001) determines this access as the unauthorized use of the encryption key, and returns an error. Thereby, the spoofing is prevented.

When the second non-secure CPU 1301 having the second user ID tries to access the encryption key stored in the RAM 209, if the user ID information does not include the second user ID, the second non-secure CPU 1301 is prohibited from accessing the encryption key by the above configuration.

In the foregoing, the invention made by the inventors of the present application has been concretely described based on the embodiments. However, it is needless to say that the present invention is not limited to the foregoing embodiments, and various modifications can be made within the scope of the present invention.

What is claimed is:

1. A semiconductor device comprising:
a random access memory (RAM) configured to store an encryption key;
a secure central processing unit (CPU) configured to access the encryption key stored in the RAM; and
a first non-secure CPU which is connected to the RAM via a key access protect module and has a first user ID,
wherein the key access protect module stores user ID information of a non-secure CPU which is permitted to access the encryption key stored in the RAM, in association with the encryption key, and
when the first non-secure CPU tries to access the encryption key stored in the RAM, if the stored user ID information and the first user ID match each other, the key access protect module permits the first non-secure CPU to access the encryption key.

2. The semiconductor device according to claim 1,
wherein the key access protect module includes:
an access protect register configured to set the user ID information of the non-secure CPU which is permitted to access the encryption key stored in the RAM; and
a first user ID checker configured to, when the non-secure CPU tries to access the encryption key stored in the RAM, confirm whether the access protect register includes the user ID information of the non-secure CPU, and to determine whether to permit the access in response to a confirmation result.

3. The semiconductor device according to claim 2, further comprising:
an advanced encryption standard (AES) engine with a function to encrypt information which has not been encrypted yet and to decrypt the encrypted information,
wherein the first non-secure CPU is connected to the RAM via the AES engine to permit the AES engine to use the encryption key.

4. The semiconductor device according to claim 3,
wherein the key access protect module further includes
a second user ID checker configured to, when the first non-secure CPU uses the encryption key, determine whether the first non-secure CPU is permitted to access the encryption key.

5. The semiconductor device according to claim 1, comprising:
a second non-secure CPU configured to be connected to the RAM via the key access protect module and to have a second user ID,
wherein, when the second non-secure CPU tries to access the encryption key stored in the RAM, if the user ID information does not include the second user ID, the key access protect module prohibits the second non-secure CPU from accessing the encryption key.

6. The semiconductor device according to claim 1,
wherein the secure CPU has a 0-th user ID,
each of the secure CPU and the first non-secure CPU is connected to the RAM and the access protect register of the key access protect module via an ID protect, and
the ID protect permits the CPU having the 0-th user ID to access the RAM and the access protect register, thereby permitting the secure CPU to access the RAM and the access protect register.

7. The semiconductor device according to claim 3, comprising:
a network module configured to transmit a cipher text encrypted by the AES engine.
